(19) United States
(12) Patent Application Publication
(10) Pub. No.: US 2024/0152105 A1
(43) Pub. Date: May 9, 2024

(54) OPERATION ADJUSTMENT SYSTEM, OPERATION ADJUSTMENT METHOD, AND OPERATION ADJUSTMENT PROGRAM

(71) Applicant: KABUSHIKI KAISHA YASKAWA DENKI, Kitakyushu-shi (JP)

(72) Inventors: Ryo KABUTAN, Kitakyushu-shi (JP); Ryohei SUZUKI, Tokyo (JP); Takeshi UEDA, Kitakyushu-shi (JP); Masayuki MORI, Kitakyushu-shi (JP)

(73) Assignee: KABUSHIKI KAISHA YASKAWA DENKI, Kitakyushu-shi (JP)

(21) Appl. No.: 18/416,887

(22) Filed: Jan. 19, 2024

Related U.S. Application Data
(63) Continuation of application No. PCT/JP2022/027890, filed on Jul. 15, 2022.

(30) Foreign Application Priority Data
Jul. 26, 2021 (JP) 2021-121328

(51) Int. Cl. G05B 19/042

(52) U.S. Cl. CPC G05B 19/042; G05B 2219/49061

(57) ABSTRACT

An operation adjustment system includes estimation circuitry and generation circuitry. The estimation circuitry is configured to generate a calculation model based on a plurality of pairs of a parameter set and an evaluation index. The calculation model indicates a relationship between the parameter set and the evaluation index. The parameter set affects an operation of a motor control device. The evaluation index relates to a machine operated according to the parameter set by the motor control device. The generation circuitry is configured to generate a new parameter set based on the calculation model in order to update the calculation model with the new parameter set.

### CROSS-REFERENCE TO RELATED APPLICATIONS

The present application is a continuation application of International Patent Application No. PCT/JP2022/027890, filed Jul. 15, 2022, which claims priority to Japanese Patent Application No. 2021-121328, filed Jul. 26, 2021. The contents of these applications are incorporated herein by reference in their entirety.

### TECHNICAL FIELD

An aspect of the present disclosure relates to an operation adjustment system, an operation adjustment method, and a non-transitory computer readable storage medium.

### DISCUSSION OF THE BACKGROUND

Japanese Patent Application Laid-Open No. 2020-35159 describes a parameter adjustment device that adjusts a control parameter of a controller that controls a control target. The device includes a data acquisition unit for acquiring a control parameter suitable for the operation of the controlled object as a label datum, and a learning part for generating a learning model by machine learning of the relation between the command and the control parameter.

### SUMMARY OF THE INVENTION

According to one aspect of the present invention, an operation adjustment system includes estimation circuitry and generation circuitry. The estimation circuitry is configured to generate a calculation model based on a plurality of pairs of a parameter set and an evaluation index. The calculation model indicates a relationship between the parameter set and the evaluation index. The parameter set affects an operation of a motor control device. The evaluation index relates to a machine operated according to the parameter set by the motor control device. The generation circuitry is configured to generate a new parameter set based on the calculation model in order to update the calculation model with the new parameter set.

According to another aspect of the present invention, an operation adjustment method includes generating a calculation model based on a plurality of pairs of a parameter set and an evaluation index, generating a new parameter set based on the calculation model in order to update the calculation model with the new parameter set, and executing, via at least one processor, the generating the calculation model and the generating the new parameter set.

According to the other aspect of the present invention, a non-transitory computer readable storage medium retrievably stores a computer-executable program therein. The computer-executable program causes a computer to perform an operation adjustment method. The method includes generating a calculation model based on a plurality of pairs of a parameter set and an evaluation index, and generating a new parameter set based on the calculation model in order to update the calculation model with the new parameter set. The calculation model indicates a relationship between the parameter set and the evaluation index. The parameter set affects an operation of a motor control device. The evaluation index relates to a machine operated according to the parameter set by the motor control device.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a diagram showing an example of application of an operation adjustment system.

FIG. 2 is a diagram showing an example of a hardware configuration of a computer used for the operation adjustment system.

FIG. 3 is a flowchart showing an example of processing in the operation adjustment system 10.

FIG. 4 is a graph illustrating the concept of Bayesian optimization.

FIG. 5 is a graph illustrating the concept of multi-objective optimization.

### DESCRIPTION OF THE EMBODIMENTS

Hereinafter, embodiments of the present disclosure will be described in detail with reference to the accompanying drawings. In the description of the drawings, the same or equivalent elements are denoted by the same reference numerals, and redundant description will be omitted.

[System Configuration]

In the present embodiment, an example of an operation adjustment system according to the present disclosure is shown as a component of a motor control system 1. The motor control system 1 is a control system that supplies electric power to a motor of a machine.

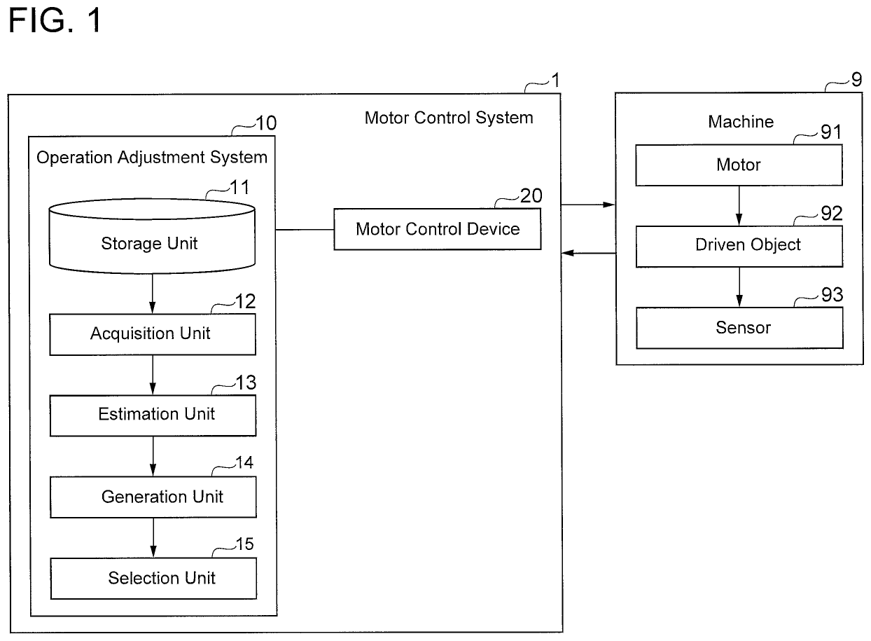

FIG. 1 is a diagram illustrating an example of a configuration of a motor control system 1 and also illustrating an example of application of an operation adjustment system 10. In this example, the motor control system 1 includes an operation adjustment system 10 and a motor control device 20, and is connected to a machine 9. The operation adjustment system 10 and the motor control device 20 are connected to each other via a communication network. The communication network connecting the devices may be a wired network or a wireless network. The communication network may include at least one of the internet and an intranet. Alternatively, the communication network may be implemented simply by a single communication cable. FIG. 1 shows one motor control device 20 and one machine 9, and shows a configuration in which one machine 9 is connected to one motor control device 20. However, the number of devices and the connection method are not limited to the example of FIG. 1. For example, the motor control device 20 may be connected to a plurality of machines 9.

The machine 9 is a device that receives power and performs a predetermined operation according to a purpose to execute useful work. For example, the machine 9 may be an industrial machine, a machine tool, a robot, or a household appliance. In one example, the machine 9 includes a motor 91, a driven object 92, and a sensor 93.

The motor 91 is a device that generates power for driving a driven object 92 that processes a workpiece in accordance with electric power supplied from the motor control device 20. The motor 91 may be a rotary motor that rotates the driven object 92 or a linear motor that displaces the driven object 92 along a straight line. The motor 91 may be a synchronous motor or an induction motor. The motor 91 may be a permanent magnet synchronous motor such as a surface permanent magnet (SPM) motor or an interior permanent magnet (IPM) motor. The motor 91 may be a synchronous motor having no permanent magnet, such as a synchronous reluctance motor. The motor 91 may be a DC motor or an AC motor.

The sensor 93 is a device that detects a response of the machine 9 that operates with the electric power from the motor control device 20. The response is an output of a machine in response to a command that is an instruction for controlling the machine. For example, the response indicates information regarding at least one of the operation and the state of the machine 9. The response may indicate information about at least one of the operation and the state of the motor 91, and may indicate at least one of the shaft speed and the magnetic pole position of the motor 91, for example. The response may indicate information on at least one of the motion and the state of the driven object 92, and may indicate, for example, at least one of the position and the speed of the driven object 92. When the motor 91 is a rotary motor, the rotation angle of the driven object 92 by the motor 91 corresponds to the “position”, and the rotation speed of the driven object 92 by the motor 91 corresponds to the “speed”. In one example, the sensor 93 is a rotary encoder that outputs a pulse signal having a frequency proportional to the operation speed of the driven object 92. The rotary encoder can acquire both the position and the speed of the driven object 92. The sensor 93 transmits a response signal indicating the response to the motor control system 1. The response may be a value obtained by the sensor 93 or may be represented by a value calculated or processed by a given operation or algorithm.

The motor control device 20 is a device for causing the output of the motor 91 to follow a command from a host controller. The motor control device 20 generates electric power for driving the motor 91 based on a command from the host controller, and supplies the electric power to the motor 91. The supplied electric power corresponds to a driving force command such as a torque command or a current command. The motor control device 20 may be, for example, an inverter or a servo amplifier. The motor control device 20 may be incorporated into the machine 9. In one example, the motor control device 20 corresponds to a plurality of control modes, and supplies electric power to the motor 91 in accordance with a selected control mode.

The operation adjustment system 10 is a computer system that generates a parameter set of the motor control device 20 in order to support adjustment of the operation of the machine 9. The parameter set is a set of at least one parameter that affects the operation of the motor control device 20 in response to a command. Currently, an operator manually adjusts or readjusts the parameter set of the motor control device 20 in order to operate the machine 9 as intended by the user. For example, the operator adjusts the vibration suppression function for suppressing the vibration caused by the fluctuation of the load torque in the machine 9. The adjustment is performed in consideration of the hardware configuration of the motor control device 20 or the machine 9. However, it is very difficult or impossible to specify the causal relationship between the parameter set and the operation of the machine 9, and the adjustment largely depends on the experience of the operator. Generally, the adjustment work requires a time of, for example, half a day to one day. The operation adjustment system 10 automatically generates and provides a parameter set of the motor control device 20 expected to cause the machine 9 to perform a desired operation. It is expected that the operation of the machine 9 can be efficiently adjusted by using this parameter set. For example, it is possible to adjust the operation of the machine 9 without intervention of a worker or while reducing a load of a manual work.

When the motor control device 20 to which a certain parameter set is applied operates the machine 9, the machine 9 exhibits a behavior or a phenomenon corresponding to the parameter set. The operation adjustment system 10 obtains information indicating the behavior or phenomenon of the machine 9 as the evaluation index. By referring to the evaluation index, it is possible to know whether or not the machine 9 operates as intended by the user. In one example, the evaluation index indicates the degree of a phenomenon that occurs due to the operation of the machine 9. An example of such a phenomenon is vibration.

Both the parameter set and the evaluation index can be expressed using at least one arbitrary physical property value. In one example, the operation adjustment system 10 generates a parameter set for suppressing the vibration generated in the machine 9, in other words, a parameter set applied to the motor control device 20 having a function of suppressing the vibration. An example of this parameter set is a combination of a feedback gain, a phase of a feedforward torque, and a magnitude of the torque. An effective value measured by a vibration sensor which is an example of the sensor 93 (this is also referred to as a “vibration effective value”) is an example of the evaluation index corresponding to this parameter set. Alternatively, the evaluation index may be the effective value of the vibration and the effective value of the current supplied to the motor 91 (also referred to as “current effective value”). When the effective value of the vibration and the effective value of the current are considered as the evaluation index, the operation adjustment system 10 generates a parameter set that can suppress both the vibration and the power consumption in the machine 9. In general, when the function of suppressing the vibration is activated, the output current increases, and thus the vibration and the power consumption have a trade-off relationship.

The operation adjustment system 10 generates a new parameter set based on a plurality of pairs of a parameter set and an evaluation index related to the machine 9 operated by the motor control device 20 with the parameter set. Each of the plurality of pairs indicates a correspondence between a parameter set and the evaluation index. Data indicating the plurality of pairs is automatically or manually stored in a given storage unit. The operation adjustment system 10 generates a calculation model indicating a relationship between the parameter set and the evaluation index based on the data, and generates a new parameter set based on the calculation model. The new parameter set is a parameter set that is not indicated by any of the plurality of pairs used to generate the calculation model.

The motor control device 20 operates the machine 9 by the new parameter set. As a result, a new pair of the new parameter set and the new evaluation index related to the operated machine 9 is obtained.

The operation adjustment system 10 updates the calculation model based on the new pair, and further generates a new parameter set based on the updated calculation model. In one example, the operation adjustment system 10 repeats the acquisition of a new pair, the update of the calculation model, and the generation of a new parameter set. By obtaining at least a new parameter set, it is possible to specify a parameter set for operating the machine 9 as intended by the user.

In one example, the operation adjustment system 10 outputs a parameter set estimated to be optimal for operating the machine 9. By applying the optimal parameter set to the motor control device 20, the machine 9 can be operated in an ideal state or a state close to the ideal state.

When the motor control device 20 corresponds to a plurality of control modes, the operation adjustment system 10 may repeat the acquisition of a plurality of pairs, the generation or update of the calculation model, and the generation of a new parameter set for each control mode. In this case, the operation of the machine 9 can be efficiently adjusted for each of the plurality of control modes, and the machine 9 can be operated as intended by the user.

FIG. 1 also shows an example of a functional configuration of the operation adjustment system 10. In one example, the operation adjustment system 10 includes a storage unit 11, an acquisition unit (an example of “acquisition circuitry”) 12, an estimation unit (an example of “estimation circuitry”) 13, a generation unit (an example of “generation circuitry”) 14, and a selection unit (an example of “selection circuitry”) 15 as functional components. The storage unit 11 is a functional module that stores a plurality of pairs of parameter sets and evaluation indexes. The acquisition unit 12 is a functional module that acquires the plurality of pairs from the storage unit 11. The estimation unit 13 is a functional module that generates the calculation model indicating the relationship between the parameter set and the evaluation index based on the plurality of pairs. The generation unit 14 is a functional module that generates a new parameter set based on the calculation model. The selection unit 15 is a functional module that selects a specific parameter set from a set of a plurality of parameter sets indicated by a plurality of pairs and a new parameter set.

The operation adjustment system 10 can be realized by any type of computer. The computer may be a general-purpose computer such as a personal computer or a business server, or may be incorporated in a dedicated apparatus that executes specific processing. The operation adjustment system 10 may be realized by one computer or may be realized by a distributed system including a plurality of computers.

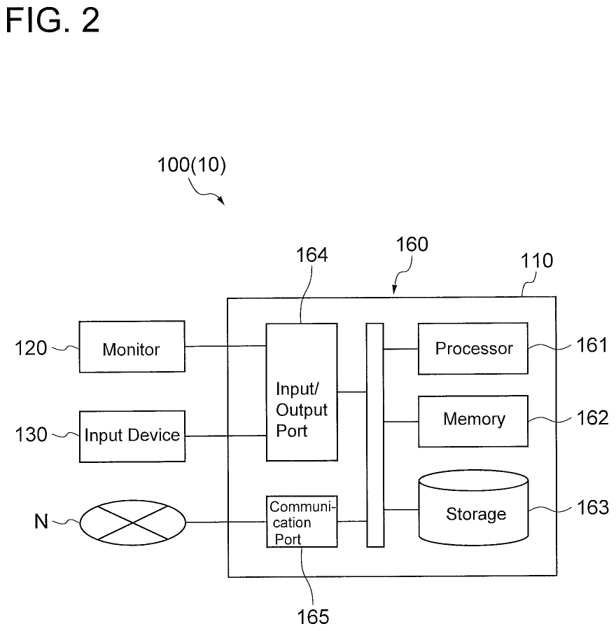

FIG. 2 is a diagram illustrating an example of a hardware configuration of a computer 100 used for the operation adjustment system 10. In this example, the computer 100 includes a main body 110, a monitor 120, and an input device 130.

The main body 110 is a device including a circuit 160. The circuit 160 includes at least one processor 161, a memory 162, a storage 163, an input/output port 164, and a communication port 165. The storage 163 records a program for configuring each functional module of the main body 110. The storage 163 is a computer-readable recording medium such as a hard disk, a nonvolatile semiconductor memory, a magnetic disk, or an optical disk. The memory 162 temporarily stores the program loaded from the storage 163, the calculation result of the processor 161, and the like. The processor 161 configures each functional module by executing a program in cooperation with the memory 162. The input/output port 164 inputs and outputs an electrical signal to and from the monitor 120 or the input device 130 in response to a command from the processor 161. The input/output port 164 may input and output an electrical signal to and from another device. The communication port 165 performs data transmission with other devices via the communication network N in accordance with a command from the processor 161.

The monitor 120 is a device for displaying information output from the main body 110. The monitor 120 may be any device as long as it can display graphics, and a liquid crystal panel is a specific example thereof.

The input device 130 is a device for inputting information to the main body 110. The input device 130 may be any device as long as desired information can be input, and specific examples thereof include an operation interface such as a keypad, a mouse, and an operation controller.

The monitor 120 and the input device 130 may be integrated as a touch panel. For example, the main body 110, the monitor 120, and the input device 130 may be integrated as in a tablet computer.

[Operation Adjustment Method]

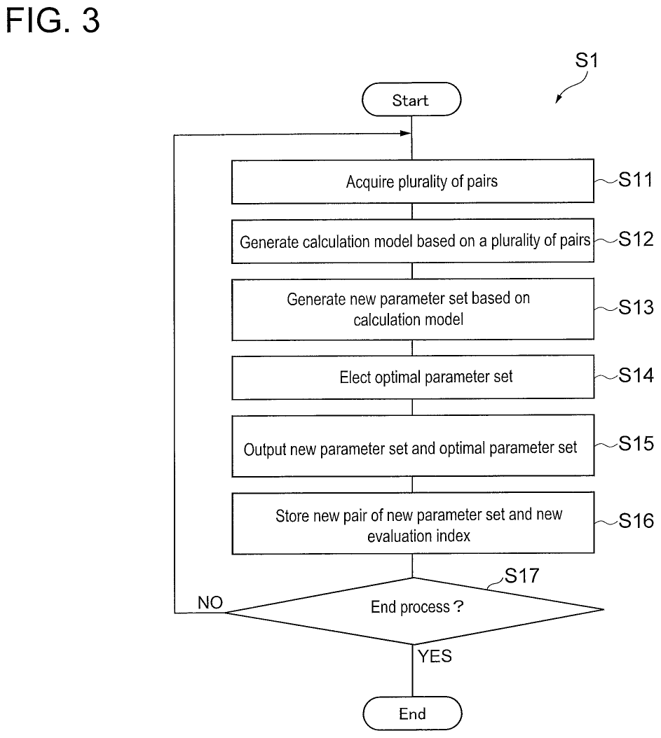

As an example of the operation adjustment method according to the present disclosure, an example of a processing procedure executed by the operation adjustment system 10 will be described with reference to FIG. 3. FIG. 3 is a flowchart showing an example of processing in the operation adjustment system 10 as a process flow S1. That is, the operation adjustment system 10 executes the process flow S1. When the motor control device 20 corresponds to a plurality of control modes, the operation adjustment system 10 executes the process flow S1 for each control mode.

The process flow S1 is based on the premise that the storage unit 11 has already stored a plurality of pairs of parameter sets and evaluation indexes. For example, the parameter set may be generated by a given algorithm such as uniformly distributed random numbers, normally distributed random numbers, Latin hypercube sampling, etc. Alternatively, a parameter set that has already been obtained empirically may be used. In any case, the evaluation index is prepared for each parameter set. For example, the parameter set is applied to the motor control device 20, and the motor control device 20 is actually operated to operate the machine 9. Then, the time series data obtained by the sensor 93 of the machine 9 is collected, and the evaluation index is calculated based on the time series data. By performing this series of processing for each parameter set, the evaluation index is obtained for each parameter set. In one example, the storage unit 11 stores a plurality of pairs obtained by such a method.

In step S11, the acquisition unit 12 acquires a plurality of pairs by referring to the storage unit 11. For example, the acquisition unit 12 reads all pairs stored in the storage unit 11. When the motor control device 20 corresponds to a plurality of control modes, the acquisition unit 12 reads a plurality of pairs corresponding to a certain control mode.

In step S12, the estimation unit 13 generates the calculation model indicating the relationship between the parameter set and the evaluation index based on the plurality of pairs. The calculation model can be said to be a model for estimating the relationship of the black box. When the motor control device 20 corresponds to a plurality of control modes, the calculation model is generated for each control mode.

The estimation unit 13 may execute regression based on a plurality of pairs, estimate a function indicating the relationship between the parameter set and the evaluation index, and generate the calculation model including the function. Regression refers to obtaining a relationship between an input and an output. The output may be a continuous value or a discrete value. The estimation unit 13 estimates a function having the parameter set as an input value and the evaluation index as an output value. For example, the estimation unit 13 estimates the function by using Gaussian process regression as the regression, and generates the calculation model including the function. Alternatively, the estimation unit 13 may estimate a function of the regression by using kernel density estimation or a deep neural network, and generate the calculation model including the function. The learned model generated by the deep neural network is an example of a function.

The estimation unit 13 may generate the calculation model including the uncertainty of the relationship between the parameter set and the evaluation index. The uncertainty is information indicating how certain the relationship is. For example, the estimation unit 13 may calculate a variance indicating the uncertainty and generate the calculation model including the variance. In any case of using any of the Gaussian process regression, the kernel density estimation, and the deep neural network, the estimation unit 13 can generate the calculation model including the variance. For example, the estimation unit 13 may calculate the uncertainty such as the variance for a function indicating the relationship between the parameter set and the evaluation index.

The estimation unit 13 may generate the calculation model corresponding to a plurality of evaluation indexes. For example, the estimation unit 13 may acquire the integrated evaluation index by integrating the plurality of evaluation index, and may generate the calculation model indicating the relationship between the parameter set and the integrated evaluation index. The integrated evaluation index is a single index set based on the plurality of evaluation index, and therefore can be represented by a single variable.

The estimation unit 13 may calculate the integrated evaluation index by a given function for integrating the plurality of evaluation index. As an example, when the vibration effective value E_{vibe} and the current effective value E_{curr} are used as the plurality of evaluation indexes, the estimation unit 13 may calculate the integrated evaluation indexes E_{integ} by the following Equation (1). The coefficient α is a constant set in advance to balance the evaluation between the vibration and the current consumption which are in a trade-off relationship.

E_{integ}=E_{vibe}×E_{curr}+α(E_{vibe}+E_{curr}) (1)

The first term on the right side indicates an object to be relatively reduced. The second term on the right side is a penalty term. The penalty term allows the integrated evaluation index to be calculated so that the vibration effective value and the current effective value are balanced.

The estimation unit 13 may calculate the integrated evaluation index by multi-objective optimization based on the plurality of evaluation index. The multi-objective optimization is an optimization method for simultaneously obtaining a plurality of objective functions. In general, the objective functions considered by this approach are in a trade-off relationship. In one example, the estimation unit 13 calculates the integrated evaluation index such as the number of wins and losses and the winning percentage based on the multi-objective optimization. The first parameter set winning (also referred to as “dominating”) the second parameter set means that the first parameter set is superior to the second parameter set for all of the plurality of evaluation index.

In step S13, the generation unit 14 generates a new parameter set based on the calculation model. For example, the generation unit 14 may generate a new parameter set using a function.

The generation unit 14 may generate a new parameter set such that the predicted value of the evaluation index based on the calculation model is closer to a given reference than the evaluation index used to generate the calculation model, that is, the plurality of evaluation index indicated by the plurality of pairs. The given criterion is, for example, a condition set to operate the machine 9 as intended by the user. When the evaluation index indicates the degree of a phenomenon that occurs due to the operation of the machine 9, the generation unit 14 generates a new parameter set such that the degree of the phenomenon changes toward a given reference. The expression “the degree of the phenomenon changes toward a given reference” means that a value closer to the given reference than the degree of any phenomenon indicated by the plurality of pairs is obtained as the predicted value of the degree of the phenomenon.

The generation unit 14 may generate a new parameter set so that the uncertainty decreases in at least a part of the relationship between the parameter set and the evaluation index. The new evaluation index is obtained by operating the machine 9 by the motor control device 20 to which the new parameter set is applied. As a result, a new relationship between the parameter set and the evaluation index is obtained, and the uncertainty for the relationship between the parameter set and the evaluation index is reduced accordingly.

In one example, the operation adjustment system 10 performs the generation of the calculation model and the generation of the new parameter set (i.e., steps S12 and S13) by Bayesian optimization. In this case, the estimation unit 13 estimates a function indicating the relationship between the parameter set and the evaluation index by using Gaussian process regression, and calculates a variance indicating an uncertainty of the function. A generation unit 14 calculates a given acquisition function based on the result of the Gaussian process regression, and generates a parameter set in which the acquisition function becomes maximum as a new parameter set. The acquisition function may be based on any strategy. In one example, the acquisition function is expressed as μ+κσ, with the mean μ and variance σ of the function. The mean μ means exploitation of known information, and the variance σ means exploration. The coefficient κ is a parameter representing the balance between the utilization and the search.

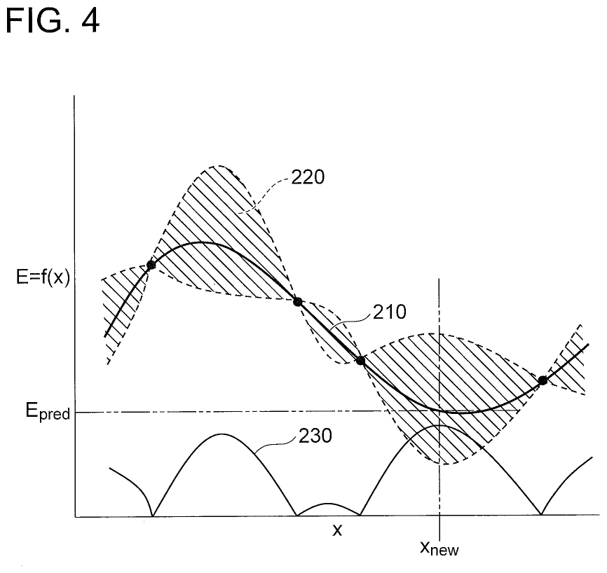

FIG. 4 is a graph illustrating the concept of Bayesian optimization. The horizontal axis of the graph indicates a parameter set x which is an input. The vertical axis represents the evaluation index E as outputs. If the function estimated by the Gaussian process regression is f, E=f (x). Curve 210 shows the function f (i.e., the relationship between the parameter set and the evaluation index) obtained by Gaussian process regression, which corresponds to the mean μ. Region 220 represents the variance indicating the uncertainty of the function. Points on the curve 210 represent pairs of known correspondences between parameter sets and the evaluation index. The graph also shows a curve 230 showing the result of the capture function. In this example, the generation unit 14 generates a parameter set x_{new} in which the acquisition function is maximized as a new parameter set. The evaluation index E_{pred} is the predicted value of the evaluation index corresponding to this new parameter set.

As an example of the process using the integrated evaluation index, the operation adjustment system 10 may execute the generation of the calculation model and the generation of the new parameter set (that is, steps S12 and S13) by multi-objective Bayes optimization which is a method of solving multi-objective optimization in the framework of Bayes optimization. In the multi-objective Bayes optimization, the generation unit 14 calculates a given acquisition function and generates a parameter set in which the acquisition function is maximized as a new parameter set. In the multi-objective Bayes optimization, the acquisition function may also be based on any strategy.

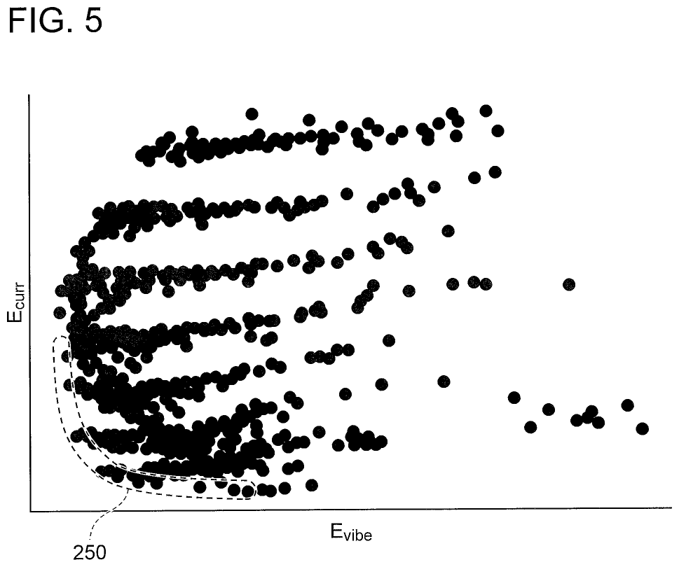

FIG. 5 is a graph illustrating the concept of multi-objective optimization. The horizontal axis and the vertical axis of the graph respectively indicate the vibration effective value E_{vibe} and the current effective value E_{curr}. The individual points indicate the known correspondence of those two evaluation index, which are feasible solutions. In this example, it is preferable to suppress both the vibration and the power consumption which are in a trade-off relationship. The optimal solution obtained by multi-objective optimization is a solution that is not dominated by any other feasible solution, which is called a Pareto optimal solution. In the example of FIG. 5, the Pareto optimal solution is assumed to lie in or near region 250.

Returning to FIG. 3, in step S14, the selection unit 15 selects an optimal parameter set from a set of a plurality of parameter sets indicated by a plurality of pairs and a new parameter set. The optimal parameter set is a parameter set corresponding to the best evaluation index at this time. For example, the selection unit 15 may select a parameter set in which the evaluation index satisfies a given criterion, or may select a parameter set in which the evaluation index is closest to a given criterion.

In step S15, the selection unit 15 outputs the new parameter set and the optimal parameter set. It should be noted that in some cases the new parameter set may also be the optimal parameter set. In one example, the selection unit 15 may store the parameter sets in a recording medium such as the storage 163. Alternatively, the selection unit 15 may display the parameter sets on the monitor 120 in a format such as text. The selection unit 15 may transmit the new parameter set to the motor control device 20 in order to apply the new parameter set to the motor control device 20.

In step S16, the storage unit 11 stores a new pair of a new parameter set and a new evaluation index. The motor control device 20 to which the new parameter set is applied is actually operated to operate the machine 9, and thus it is possible to obtain a new evaluation index. As a result, a new pair of a new parameter set and a new evaluation index is obtained. This new pair is stored in the storage unit 11. The operation of the motor control device 20 based on the new parameter set, the calculation or acquisition of the new evaluation index, and the storage of the new pair in the storage unit 11 may be automatically executed by the motor control system 1 or the operation adjustment system 10, or may be manually performed.

In step S17, the operation adjustment system 10 determines whether or not to end the process based on an arbitrary end condition. The termination condition may be that the steps S11 to S16 have been executed a given number of times, or that a given calculation time has elapsed. Alternatively, the end condition may be that the difference between the previously obtained evaluation index and the currently obtained evaluation index becomes equal to or less than a given threshold, that is, the evaluation index has stopped or converged. Alternatively, the termination condition may be that an evaluation value satisfying a given criterion is obtained. Alternatively, the termination condition may be that the uncertainty (for example, the variance) in the entire relationship between the parameter set and the evaluation index becomes equal to or less than a predetermined value.

When it is determined that the process is not to be ended (NO in step S17), the process returns to step S11. In this case, the processing of steps S11 to S17 is repeated.

In the repeated step S11, the acquisition unit 12 acquires a plurality of pairs by referring to the storage unit 11. The plurality of pairs acquired at this stage include the new pair stored in step S16, and therefore the acquisition unit 12 acquires one more pair of the parameter set and the evaluation index than in the previous step S11.

In the repeated step S12, the estimation unit 13 generates the calculation model indicating the relationship between the parameter set and the evaluation index based on the plurality of acquired pairs. Since the plurality of pairs used in this process includes a new pair, the calculation model generated at this stage generally changes from the calculation model generated in the previous step S12. That is, the estimation unit 13 updates the calculation model based on the acquired new pair. The updated calculation model may indicate the relationship between the parameter set and the evaluation index with higher accuracy than the calculation model generated last time. Alternatively, the updated calculation model may have a lower uncertainty than the previously generated calculation model.

In the repeated step S13, the generation unit 14 generates a new parameter set based on the calculation model. As described above, the generation unit 14 may generate a new parameter set such that the predicted value of the evaluation index is closer to a given reference than the known evaluation index or such that the uncertainty decreases in at least a part of the relationship between the parameter set and the evaluation index.

Thereafter, the processing of steps S14 to S17 is executed again. The optimal parameter set selected and output at this stage may be different from or the same as the optimal parameter set selected in the previous step S14.

In one example, the accuracy of the calculation model indicating the relationship between the parameter set and the evaluation index is increased by repeating the processing of steps S11 to S17. In another example, the iterative process may result in a decreasing uncertainty of the calculation model (i.e., the calculation model is updated to a more probable version). When the evaluation index indicates the degree of a phenomenon that occurs due to the operation of the machine 9, the generation unit 14 generates a new parameter set in the iterative process so that the degree of the phenomenon changes toward a given reference. Such an iterative process can be said to be a process of searching for a solution to an optimization problem such as a minimization problem or a maximization problem. When the phenomenon is the vibration, the generation unit 14 generates a new parameter set such that the vibration is equal to or less than a given reference during the iterative process.

When it is determined in step S17 that the process is to be ended (YES in step S17), the operation adjustment system 10 ends the process flow S1. The parameter set that is finally determined to be optimal is selected and output in the final steps S14 and S15. In one example, the evaluation index corresponding to the parameter set meet a given criteria. That is, the selection unit 15 selects a parameter set such that the evaluation index satisfies a given criterion. By applying the finally selected optimal parameter to the motor control device 20, the machine 9 can be operated as intended by the user.

By executing the process flow S1, a parameter set estimated to be optimal is obtained. When there are a plurality of parameters to be adjusted, these parameters may be divided into a plurality of parameter sets, and the process flow S1 may be sequentially executed for each of the plurality of parameter sets. That is, the plurality of parameter sets may be adjusted in a stepwise manner. For example, the operation adjustment system 10 adjusts the phases of the torques by executing the process flow S1 (for example, repetition of steps S11 to S17) for the parameter set including the phases of the torques. Next, the operation adjustment system 10 adjusts the magnitude of the torque by executing the process flow S1 (for example, repeating steps S11 to S17) for the parameter set including the magnitude of the torque. That is, the operation adjustment system 10 may adjust the phase of the torque in preference to the magnitude of the torque.

[Program]

Each functional module of the operation adjustment system 10 is realized by reading the operation adjustment program onto the processor 161 or the memory 162 and causing the processor 161 to execute the program. The operation adjustment program includes a code for realizing each functional module of the operation adjustment system 10. The processor 161 operates the input/output port 164 or the communication port 165 in accordance with the operation adjustment program, and reads and writes data in the memory 162 or the storage 163. Each functional module of the operation adjustment system 10 is realized by such processing.

The operation adjustment program may be provided by being fixedly recorded in a non-transitory recording medium such as a CD-ROM, a DVD-ROM, or a semiconductor memory. Alternatively, the operation adjustment program may be provided as a data signal superimposed on a carrier wave via a communication network.

[Effects]

As described above, the operation adjustment system according to an aspect of the present disclosure includes the estimation unit that generates the calculation model indicating the relationship between the parameter set and the evaluation index based on a plurality of pairs of the parameter set affecting the operation of the motor control device in response to the command and the evaluation index related to the machine operated by the motor control device using the parameter set, and the generation unit that generates a new parameter set based on the calculation model.

An operation adjustment method according to an aspect of the present disclosure is the operation adjustment method executed by the operation adjustment system 10 including at least one processor, and includes a step of generating a calculation model indicating a relationship between a parameter set and an evaluation index based on a plurality of pairs of the parameter set affecting an operation of the motor control device in response to a command and the evaluation index related to a machine operated by the motor control device with the parameter set, and a step of generating a new parameter set based on the calculation model.

An operation adjustment program according to an aspect of the present disclosure causes a computer to execute a step of generating a calculation model indicating a relationship between a parameter set and an evaluation index based on a plurality of pairs of the parameter set affecting an operation of a motor control device in response to a command and the evaluation index related to a machine operated by the motor control device with the parameter set, and a step of generating a new parameter set based on the calculation model.

In such an aspect, a parameter set for controlling a machine is automatically obtained based on the calculation model in which the evaluation index related to the machine is considered. Thus, it is possible to efficiently adjust the operation of the machine. Further, since the relationship between the parameter set and the evaluation index is represented by the calculation model, it is possible to obtain an appropriate parameter set even in a machine system in which it is difficult to predict the influence of a command to the motor control device on the operation of the machine.

The operation adjustment system according to another aspect may further include the acquisition unit that acquires a new pair of the generated new parameter set and the new evaluation index related to the machine operated by the motor control device with the new parameter set, the estimation unit may update the calculation model based on the acquired new pair, and the generation unit may further generate a new parameter set based on the updated calculation model. By updating the calculation model by increasing the parameter set, the accuracy of the calculation model can be increased.

In the operation adjustment system according to another aspect, the estimation unit may execute regression to estimate a function indicating the relationship and generate the calculation model including the function. The function obtained by regression can clearly specify the relationship between the parameter set and the evaluation index.

In the operation adjustment system according to another aspect, the estimation unit may generate the calculation model by using Gaussian process regression as the regression. Since the Gaussian process regression has a low calculation cost of regression compared to a method such as deep learning which requires explicit learning, the update of the calculation model according to the addition of data can be immediately executed. Therefore, even if the calculation model is repeatedly updated to increase the accuracy of the calculation model, the time required for the repetition can be shortened by using the Gaussian process regression. That is, the Gaussian regression process may facilitate an increase in the accuracy of the calculation model.

In the operation adjustment system according to another aspect, the generation unit may generate a new parameter set such that the predicted value of the evaluation index based on the calculation model is closer to a given reference than the evaluation index used to generate the calculation model. Since the parameter set is generated by predicting the evaluation index related to the machine, it is possible to generate the parameter set capable of operating the machine as intended by the user.

In the operation adjustment system according to another aspect, the estimation unit may generate the calculation model including the uncertainty of the relationship, and the generation unit may generate a new parameter set such that the uncertainty decreases in at least a part of the relationship. With this configuration, the relationship between the parameter set and the evaluation index becomes more certain, and thus it is possible to acquire a parameter set that is expected to be able to operate the machine in a desired state. Further, by considering the uncertainty, it is possible to determine whether or not the parameter set needs to be continuously adjusted.

In the operation adjustment system according to another aspect, the estimation unit may calculate a variance indicating the uncertainty and generate the calculation model including the variance. By using the calculation model in which the variance is taken into consideration, the uncertainty of the relationship between the parameter set and the evaluation index can be clearly identified.

The operation adjustment system according to another aspect may further include a selection unit that selects a parameter set in which the evaluation index satisfies a given criterion. This arrangement allows a set of parameters to be obtained that is expected to be desirable for operating the machine.

In the operation adjustment system according to another aspect, the estimation unit may generate the calculation model corresponding to a plurality of evaluation indexes. With this configuration, it is possible to efficiently perform the process of adjusting the operation of the machine while balancing the plurality of evaluation indexes.

In the operation adjustment system according to another aspect, the estimation unit may generate the calculation model indicating a relationship between the parameter set and the integrated evaluation index obtained by integrating the plurality of evaluation index. By introducing the integrated evaluation index, it is possible to suppress an increase in the amount of calculation due to the number of evaluation index.

In the operation adjustment system according to another aspect, the estimation unit may calculate the integrated evaluation index by a given function for integrating the plurality of evaluation index. By adopting this configuration, the integrated evaluation index can be easily obtained by a function.

In the operation adjustment system according to another aspect, the estimation unit may calculate the integrated evaluation index by multi-objective optimization based on the plurality of evaluation index. By using multi-objective optimization, the operation of the machine can be efficiently adjusted while balancing between the plurality of evaluation indexes having a trade-off relationship.

In the operation adjustment system according to another aspect, the evaluation index may indicate the degree of a phenomenon that occurs due to the operation of the machine, and the generation unit may generate a new parameter set such that the degree of the phenomenon changes toward a given reference. With this configuration, it is possible to obtain a parameter set that makes a phenomenon associated with the operation of the machine as intended by the user.

In the operation adjustment system according to another aspect, the phenomenon may be the vibration, and the generation unit may generate a new parameter set such that the vibration is equal to or less than a reference. In this case, a parameter set for suppressing the vibration associated with the operation of the machine can be obtained.

A motor control system according to an aspect of the present disclosure includes the operation adjustment system and a motor control device. In this aspect, the operation of the machine can be efficiently adjusted.

[Modification]

The present disclosure has been described in detail based on the embodiments. However, the present disclosure is not limited to the above-described embodiments. Various modifications can be made without departing from the scope of the present disclosure.

The operation adjustment system 10 may be implemented by any policy. In the above example, the operation adjustment system 10 is separated from the motor control device 20, but the operation adjustment system may be incorporated in the motor control device 20. The operation adjustment system may be incorporated in a host controller that outputs a command to the motor control device, or may be realized as a device separate from the host controller.

In the above example, the operation adjustment system 10 includes the storage unit 11, but the storage unit may be provided outside the operation adjustment system.

The hardware configuration of the system is not limited to the mode in which each functional module is realized by executing the program. For example, at least a part of the functional modules in the above examples may be configured by a logic circuit specialized for the function, or may be configured by an application specific integrated circuit (ASIC) in which the logic circuit is integrated.

The processing procedure of the method executed by at least one processor is not limited to the above-described example. For example, some of the steps (processes) described above may be omitted, or the steps may be executed in another order. In addition, two or more arbitrary steps among the above-described steps may be combined, or some of the steps may be modified or deleted. Alternatively, other steps may be performed in addition to the above-described steps.

When comparing the magnitude relationship between two numerical values in a computer system or a computer, either of the two criteria “equal to or greater than” and “greater than” may be used, and either of the two criteria “equal to or less than” and “less than” may be used. The selection of such a criterion does not change the technical significance of the process of comparing the magnitude relationship between two numerical values.

What is claimed is:

1. An operation adjustment system comprising:
estimation circuitry configured to generate a calculation model based on a plurality of pairs of a parameter set and an evaluation index, the calculation model indicating a relationship between the parameter set and the evaluation index, the parameter set affecting an operation of a motor control device, the evaluation index relating to a machine operated according to the parameter set by the motor control device; and
generation circuitry configured to generate a new parameter set based on the calculation model in order to update the calculation model with the new parameter set.

2. The operation adjustment system according to claim 1, further comprising:
acquisition circuitry configured to acquire a new pair of the new parameter set and a new evaluation index relating to the machine operated according to the new parameter set by the motor control device,
wherein the estimation circuitry is configured to update the calculation model to obtain an updated calculation model based on the new pair, and
wherein the generation circuitry is configured to update the new parameter set according to the updated calculation model.

3. The operation adjustment system according to claim 1,
wherein the estimation circuitry is configured to perform regression to estimate a function indicating the relationship and is configured to generate the calculation model including the function.

4. The operation adjustment system according to claim 3,
wherein the estimation circuitry is configured to generate the calculation model with Gaussian process regression as the regression.

5. The operation adjustment system according to claim 1,
wherein the generation circuitry is configured to generate the new parameter set such that a predicted value of the evaluation index based on the calculation model approaches a reference from the evaluation index used to generate the calculation model.

6. The operation adjustment system according to claim 1,
wherein the estimation circuitry is configured to generate the calculation model including uncertainty of the relationship, and
wherein the generation circuitry is configured to update the parameter set so that the uncertainty decreases in at least a part of the relationship.

7. The operation adjustment system according to claim 6,
wherein the estimation circuitry is configured to calculate a variance indicating the uncertainty and generate the calculation model including the variance.

8. The operation adjustment system according to claim 1, further comprising:
selection circuitry configured to select the parameter set in which the evaluation index satisfies a criterion.

9. The operation adjustment system according to claim 1, wherein the estimation circuitry is configured to generate the calculation model corresponding to a plurality of the evaluation indexes.

10. The operation adjustment system according to claim 9,
wherein the estimation circuitry is configured to generate the calculation model indicating a relationship between the parameter set and an integrated evaluation index obtained by integrating the plurality of evaluation index.

11. The operation adjustment system according to claim 10,
wherein the estimation circuitry is configured to calculate the integrated evaluation index by a given function for integrating the plurality of evaluation index.

12. The operation adjustment system according to 10,
wherein the estimation circuitry is configured to calculate the integrated evaluation index by multi-objective optimization based on the plurality of evaluation index.

13. The operation adjustment system according to claim 1,
wherein the evaluation index indicates a degree of a phenomenon that occurs due to an operation of the machine, and
wherein the generation circuitry is configured to generate the new parameter set so that the degree of the phenomenon changes toward a reference.

14. The operation adjustment system according to claim 13,
wherein the phenomenon is vibration, and
wherein the generation circuitry is configured to generate the new parameter set so that the vibration is equal to or less than the reference.

15. The motor control system comprising:
the operation adjustment system according to claim 1; and
the motor control device.

16. An operation adjustment method comprising:
generating a calculation model based on a plurality of pairs of a parameter set and an evaluation index, the calculation model indicating a relationship between the parameter set and the evaluation index, the parameter set affecting an operation of a motor control device, the evaluation index relating to a machine operated according to the parameter set by the motor control device;
generating a new parameter set based on the calculation model in order to update the calculation model with the new parameter set; and
executing, via at least one processor, the generating the calculation model and the generating the new parameter set.

17. A non-transitory computer readable storage medium retrievably storing a computer-executable program therein, the computer-executable program causing a computer to perform an operation adjustment method, the method comprising:
generating a calculation model based on a plurality of pairs of a parameter set and an evaluation index, the calculation model indicating a relationship between the parameter set and the evaluation index, the parameter set affecting an operation of a motor control device, the evaluation index relating to a machine operated according to the parameter set by the motor control device; and
generating a new parameter set based on the calculation model in order to update the calculation model with the new parameter set.
